(19) United States
(12) Patent Application Publication
(10) Pub. No.: US 2024/0290029 A1
(43) Pub. Date: Aug. 29, 2024

(54) Systems and Methods for Creating Levels of Detail Using Perceptual Degradation

(71) Applicant: Six Impossible Things Before Breakfast Limited, Dublin (IE)

(72) Inventor: Sherry IGNATCHENKO, Weidling (AT)

(73) Assignee: Six Impossible Things Before Breakfast Limited, Dublin (IE)

(21) Appl. No.: 18/587,095

(22) Filed: Feb. 26, 2024

Related U.S. Application Data
(60) Provisional application No. 63/487,166, filed on Feb. 27, 2023.

(51) Int. Cl. G06T 15/00; G06T 7/00

(52) U.S. Cl. CPC G06T 15/005; G06T 7/0002; G06T 2207/30168

(57) ABSTRACT

The systems and methods described herein provide improved display techniques for rendering computer-generated three-dimensional models. According to one aspect of the invention, a level of detail (LOD) used to render a computer-generated three-dimensional model may be generated that meets a pre-defined quality target. The LOD may be generated by first testing a minimum LOD against a reference rendering. If the minimum LOD does not satisfy an image quality target, a two-dimensional function of mesh number of triangles and texture pixel dimensions may be used to select an LOD for the three-dimensional model that satisfies the image quality target and where another quality metric is optimized. Once an LOD that satisfies the image quality target is identified, the resultant LOD may be assigned as the LOD to be used to render the three-dimensional model for a predefined scene and/or a predefined range of distances.

### RELATED APPLICATIONS

This application claims priority to U.S. Provisional Application No. 63/487,166, entitled “Method for Creating LODs Using Perceptual Degradation,” filed on Feb. 27, 2023, the content of which is hereby incorporated herein by reference in its entirety.

### FIELD OF THE DISCLOSURE

The systems and methods described herein relate to improvements to the display technique used to render computer-generated three-dimensional models.

### BACKGROUND

In computer graphics, different levels of detail are frequently used to express the complexity of computer-generated graphics or three-dimensional models. A level of detail (or “LOD”) can be described as one or more three-dimensional models, with a certain number of triangles or vertices used, and maybe a certain texture applied. Different LODs of the same three-dimensional object may have a different number of triangles/vertices, and different resolutions and/or image quality of the textures. The tradeoff when using LODs is in the quality of a rendered three-dimensional object versus resources needed to describe and/or render the three-dimensional object. For example, a lower or minimized LOD requiring less data may be used as a placeholder while a three-dimensional model for an object is still loading to improve the experience of the user. A lower or minimized LOD may also be used when the object appears further away from the camera within a virtual environment. In contrast, a higher LOD may be needed as the distance between the user and the object decreases (e.g., when the object appears closer to the user in the virtual environment). In gaming applications (such as in video games in augmented or virtual reality), three-dimensional digital assets rendered within the game may include scenes comprising trees and buildings as well as characters, all with potentially different LODs. The LODs for those digital assets may be determined based on the three-dimensional model and/or scenes in which the digital assets are situated.

While varying LODs when rendering digital assets in virtual environments has its benefits (e.g., reduced transmission data size, reduced transmission time, and reduced memory usage), careful consideration is needed not only of the computational cost for varying detail, but also of the quality of the three-dimensional render, which may be considered as a perceptual cost. More often than not, LODs are created manually, by artists, using three-dimensional modeling tools. While automated mesh decimators (to reduce mesh complexity) and texture resizers/compressors (to reduce texture complexity) are also known, they are usually driven by parameters such as “reduce number of vertices by 5×” or “reduce texture size by 2×”, which has no immediate bearing on the quality of the three-dimensional model, and therefore the quality of the three-dimensional model still needs to evaluated manually, by a person looking at the reduced-complexity model or its renders after the decimation and/or texture complexity reduction was performed. For example, a game editor may provide a drop-down menu, so that the user may select a LOD manually from the drop-down menu. In another example, the game editor may provide a drop-down menu with different types of parameters (e.g., a number of vertices or faces of a mesh, a resolution to be used, and/or one or more other types of parameters) that can be selected by the user to determine the LOD to be used. And then, somebody (usually an artist) would need to take a look at the result and determine whether the result is satisfactory for the conditions where the LOD is going to be used (such as the range of distances from the camera where the LOD is expected to be used for rendering). This whole process often leads to LOD components (such as meshes or textures) using too many resources, resulting in poor rendering performance for the three-dimensional model. Ultimately, the goal of any LOD varying technique should be to maximize resource (computational/rendering/network/etc.) gain while minimizing perceptual impact to the user or degradation of the rendered image itself. Because conventional techniques utilize too many resources resulting in poor rendering performance, and because any manual work by artists is expensive both in terms of money and time to market, there is a need in the art for an improved technique for creating/generating LODs when rendering computer-generated three-dimensional models.

### SUMMARY OF THE DISCLOSURE

According to one aspect of the invention, the systems and methods described herein may generate an LOD to be used to render a computer-generated three-dimensional model that meets a pre-defined quality target. For a given three-dimensional model, a minimum LOD may be generated using one or more mesh decimation methods and/or texture reduction/compression methods. One or more renderings of the three-dimensional model may then be generated based on one or more input parameters. For example, the one or more input parameters may specify a predefined scene, a range of distances in which a three-dimensional model may be rendered within a predefined scene, and/or one or more other input parameters. In various implementations, a reference rendering may be generated using an original model (or the original three-dimensional art) for the three-dimensional model and an experimental rendering may be generated using the minimum LOD. Image quality metrics may be calculated for various experimental rendering as compared to a referenced rendering and used to determine whether a minimum LOD satisfies an image quality target. For example, an image quality target included within the one or more input parameters may specify a maximum acceptable deviation from a rendering of the three-dimensional model using an original model. Whether the minimum LOD satisfies the image quality target may be determined by determining whether the image quality metric for the experimental rendering is within a maximum acceptable deviation of an image quality metric for the reference rendering. If the minimum LOD satisfies the image quality target, the minimum LOD may be used as the LOD for the three-dimensional model when rendered according to the one or more input parameters. If the minimum LOD does not satisfy the image quality target, the systems and methods described herein may be configured to re-generate and select an LOD that does.

According to another aspect of the invention, the systems and methods described herein may select an LOD for a three-dimensional model that satisfies an image quality target. In various implementations, a two-dimensional function of mesh number of triangles and texture pixel dimensions may be used to identify a point where the corresponding image quality metric is within a maximum acceptable deviation from an image quality metric for a rendering of the three-dimensional model using an original model. In some implementations, this two-dimensional function may be used to find a point corresponding to an LOD where the image quality metric satisfies the image quality target and where a second quality metric is optimized. Accordingly, the point may be selected based on the point with the best value for the second quality metric that also satisfies the predefined image quality metric. In various implementations, a value indicating whether an image quality target is satisfied and a value for a second metric may be calculated for each of a set of candidate points representing individual candidate LODs. The candidate points for which the image quality target is not satisfied may be filtered out and a candidate point may be chosen from the remaining candidate points based on the value of the second metric. The LOD corresponding to that candidate point may be used as the LOD for the three-dimensional model when rendered according to the one or more input parameters.

According to another aspect of the invention, the systems and methods described herein may evaluate an original three-dimensional model and a candidate LOD in a predefined mode wherein at least one frame is rendered twice. For example, after an LOD has been identified and/or assigned for a three-dimensional model at all necessary distances and/or scenes, the LODs may be tested utilizing one or more techniques described herein. In various implementations, the candidate LODs assigned to render a three-dimensional model may be obtained. Each scene (or frame) may then be rendered twice and evaluated. For example, for a given scene (or frame), a reference rendering of the scene may be generated using an original model (or the original three-dimensional art) for the three-dimensional model, and an experimental rendering of the scene may be generated using the candidate LOD for that scene (or distance). Image quality metrics may be calculated for various experimental renderings as compared to the reference rendering and used to determine whether a candidate LOD satisfies an image quality target. Whether the candidate LOD satisfies the image quality target may be determined by determining whether the image quality metric for the experimental rendering is within a maximum acceptable deviation of an image quality metric for the reference rendering. If the candidate LOD does not satisfy the image quality target, a report may be generated that includes a list of scenes (or assigned LODs) requiring corrective action. In some implementations, a candidate LOD that does not satisfy the image quality target may be automatically adjusted or a range of distances associated with that LOD may be automatically adjusted. For example, the range of distances for the candidate LOD may be increased generally or for the particular type of scene for which the candidate LOD was assigned and did not meet the image quality target. This process may be repeated for each scene (and each LOD) until the image quality for each of a predefined set of scenes is evaluated.

These and other objects, features, and characteristics of the system and/or method disclosed herein, as well as the methods of operation and functions of the related elements of structure and the combination thereof, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

The present invention is illustrated by way of example and not limited in the accompanying figures in which like reference numerals indicate similar elements and in which:

FIG. 1 depicts a block diagram of an example of a system configured to display computer-generated three-dimensional models, according to one or more aspects described herein;

FIG. 2 depicts an example reference table comprising candidate points used to identify an LOD that satisfies the image quality target, according to one or more aspects described herein;

FIG. 3 depicts a flow diagram of an example of a method for generating an LOD to be used to render a computer-generated three-dimensional model that meets a pre-defined quality target, according to one or more aspects described herein; and

FIG. 4 depicts a flow diagram of an example of a method for evaluating an original three-dimensional model and a candidate LOD in a predefined mode wherein at least one frame is rendered twice, according to one or more aspects described herein.

These drawings are provided for purposes of illustration only and merely depict typical or example embodiments. These drawings are provided to facilitate the reader's understanding and shall not be considered limiting of the breadth, scope, or applicability of the disclosure. For clarity and ease of illustration, these drawings are not necessarily drawn to scale.

### DETAILED DESCRIPTION

Certain illustrative aspects of the systems and methods according to the present invention are described herein in connection with the following description and the accompanying figures. These aspects are indicative, however, of but a few of the various ways in which the principles of the invention may be employed and the present invention is intended to include all such aspects and their equivalents. Other advantages and novel features of the invention may become apparent from the following detailed description when considered in conjunction with the figures.

In the following detailed description, numerous specific details are set forth in order to provide a thorough understanding of the invention. In other instances, well known structures, interfaces, and processes have not been shown in detail in order not to unnecessarily obscure the invention. However, it will be apparent to one of ordinary skill in the art that those specific details disclosed herein need not be used to practice the invention and do not represent a limitation on the scope of the invention, except as recited in the claims. It is intended that no part of this specification be construed to effect a disavowal of any part of the full scope of the invention. Although certain embodiments of the present disclosure are described, these embodiments likewise are not intended to limit the full scope of the invention.

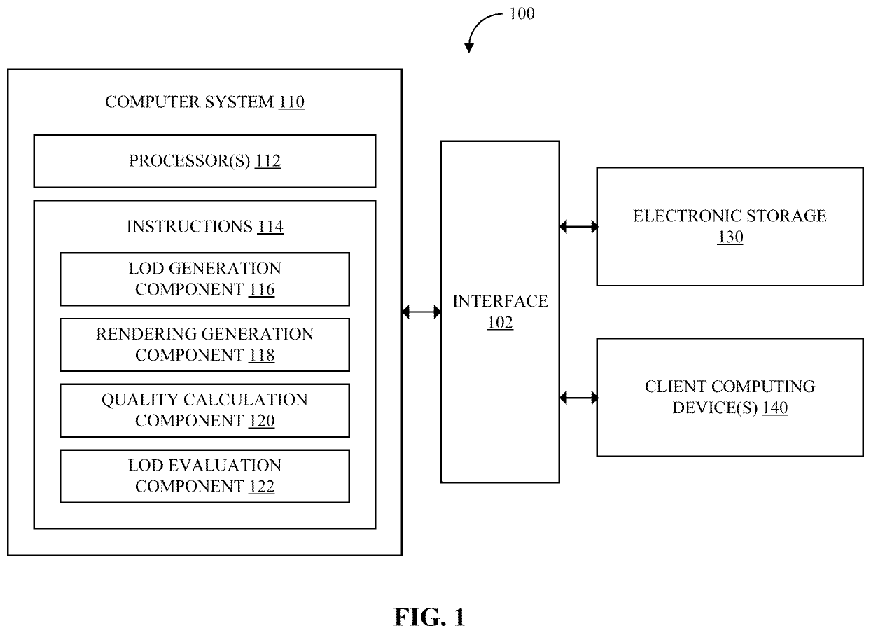

FIG. 1 illustrates an example of a system 100 configured to display computer-generated three-dimensional models, according to one or more aspects described herein. In various implementations, system 100 may include one or more of interface 102, a computer system 110, electronic storage 130, client computing device(s) 140, and/or other components. In various implementations, computer system 110 may include one or more physical processors 112 (also interchangeably referred to herein as processor(s) 112, processor 112, or processors 112 for convenience), computer readable instructions 114, and/or one or more other components. In some implementations, system 100 may include one or more external resources, such as sources of information outside of system 100, external entities participating with system 100, and/or other resources. In various implementations, system 100 may be configured to receive input from or otherwise interact with one or more users via one or more client computing device(s) 140.

In various implementations, physical processor(s) 112 may be configured to provide information processing capabilities in system 100. As such, the processor(s) 112 may comprise one or more of a digital processor, an analog processor, a digital circuit designed to process information, a central processing unit, a graphics processing unit, a microcontroller, a microprocessor, a field programmable gate array (FPGA), an application specific integrated circuit (ASIC), a System on a Chip (SoC), and/or other mechanisms for electronically processing information. Processor(s) 112 may be configured to execute one or more computer readable instructions 114. Computer readable instructions 114 may include one or more computer program components. In various implementations, computer readable instructions 114 may include an LOD generation component 116, a rendering generation component 118, a quality calculation component 120, an LOD evaluation component 122, and/or other miscellaneous computer program components. As used herein, for convenience, the various computer readable instructions 114 will be described as performing an operation, when, in fact, the various instructions program the processor(s) 112 (and therefore system 100) to perform the operation.

In various implementations, LOD generation component 116 may be configured to generate LODs to be used to render computer-generated three-dimensional models. For example, LOD generation component 116 may be configured to generate a minimum LOD for a three-dimensional model, an LOD that satisfies one or more quality targets as described further herein, and/or one or more other candidate LODs that may be used to render a computer-generated three-dimensional model. In various implementations, LOD generation component 116 may be configured to generate an LOD based on an original three-dimensional model and one or more input parameters. For example, LOD generation component 116 may be configured to obtain (e.g., via electronic storage 130) and/or receive (e.g., via client computing devices 140) a three-dimensional model and one or more input parameters. In various implementations, the original three-dimensional model may include one or more meshes and/or textures used to render the three-dimensional model. In various implementations, the one or more input parameters may include ranges of distances, predefined scenes, a target quality, and/or one or more other input parameters. For example, LOD generation component 116 may be configured to generate an LOD for a digital asset based on a distance between the digital asset and a camera and/or viewpoint (e.g., a distance away in a virtual environment at which a three-dimensional model is rendered). In such implementations, LOD generation component 116 may be configured to generate a lower LOD for the digital asset depicted at a larger distance from the camera or viewpoint, as described herein. In some implementations, the one or more input parameters may include a range of distances. In various implementations, the range of distances used as an input parameter may comprise the distances between which a specific LOD is intended to be used.

In various implementations, LOD generation component 116 may be configured to generate a minimum LOD for a three-dimensional model. For example, LOD generation component 116 may be configured to generate a minimum LOD for a given mesh or texture of a three-dimensional model using one or more now known or future developed mesh decimation methods and/or texture reduction/compression methods. In some implementations, LOD generation component 116 may be configured to decimate a mesh or texture using an existing mesh decimation method and/or by calling an external decimation program. For example, in some implementations, LOD generation component 116 may be configured to decimate a mesh or texture using one or more existing techniques described in “A General Framework for Mesh Decimation” by Leif Kobbelt et al., which was published in Proceedings of Graphics Interface on page 43 in June 1998, the contents of which are herein incorporated by reference in their entirety. In other implementations, LOD generation component 116 may be configured to decimate a mesh or texture by calling an external decimation program configured to decimate the mesh or texture to some feasible minimum, such as Simplygon, InstaLOD, or Blender Decimate Modifier. In various implementations, how much a mesh is decimated may be determined, for example, by aiming to reduce the number of polygons/triangles (or vertices) to a certain number typical for that particular type of object and known from industry practices. For example, three-dimensional models such as characters may be decimated to as low as 100 to 200 triangles, whereas houses or other structures may be decimated to as low as 12 to 30 triangles. Similarly, LOD generation component 116 may be configured to reduce (or decimate) textures of an original three-dimensional model to a feasible minimum pixel width and pixel height (e.g., to a 1×1 texture). Accordingly, LOD generation component 116 may be configured to generate a minimum LOD comprising a feasible minimum mesh and/or a feasible minimum texture.

In various implementations, rendering generation component 118 may be configured to generate one or more renderings of a three-dimensional model. For example, rendering generation component 118 may be configured to generate a rendering of a three-dimensional model by rendering a predefined scene in which the three-dimensional model is rendered based on one or more candidate LODs. In some implementations, rendering generation component 118 may be configured to generate a rendering of a three-dimensional model in a predefined scene in which the three-dimensional model is rendered based on the original three-dimensional model (e.g., a rendering in which an LOD is not applied to modify the appearance of the three-dimensional model). A rendering of a three-dimensional model based on the original three-dimensional model may be referred to herein as a “reference rendering.” In some implementations, rendering generation component 118 may be configured to generate a rendering of a three-dimensional model in a predefined scene in which the three-dimensional model is rendered based on the minimum LOD, such as the minimum LOD generated by LOD generation component 116. A rendering of a three-dimensional model based on a minimum LOD (or any other LOD different from the original three-dimensional model) may be referred to herein as an “experimental rendering.”

In various implementations, rendering generation component 118 may be configured to generate rendering(s) of a three-dimensional model based on one or more input parameters. For example, rendering generation component 118 may be configured to generate a rendering of one or more predefined scenes in which an original three-dimensional model is rendered within a range of distances specified by one or more input parameters. In some implementations, the predefined scene(s) may include typical scenes, scenes expected to be sensitive to varying LOD quality, and/or one or more other predefined scenes. For example, a scene expected to be sensitive to varying LOD quality may comprise a scene looking at the object (or three-dimensional model) as close as allowed and at an angle normal to some mesh face. In some implementations, rendering generation component 118 may be configured to generate rendering(s) by rendering a general predefined scene while moving the object or other digital asset that corresponds to the three-dimensional model between one or more distances within a range of distances specified by one or more input parameters.

In various implementations, quality calculation component 120 may be configured to calculate one or more image quality metrics of renderings of a three-dimensional model. For example, quality calculation component 120 may be configured to calculate one or more image quality metrics of various experimental renderings as compared to the reference rendering. In various implementations, quality calculation component 120 may be configured to calculate one or more different types of image quality metrics. Note that all the image quality metrics discussed herein, while known in the art as “image quality metrics”, may be considered as essentially image similarity metrics, measuring “how similar two images (usually of the same pixel resolution) are.” Also, if not specified otherwise, this document assumes such images are compared to the “reference rendering”. For example, quality calculation component 120 may be configured to calculate, for a given rendering of a three-dimensional model as compared to the reference rendering, peak signal-to-noise ratio (PSNR), mean-squared error (MSE), structural similarity index measure (SSIM), multi-scale structural similarity index measure (MS-SSIM), learned perceptual image patch similarity (LPIPS) metric, and/or one or more other image quality metrics. In some implementations, the image quality metric calculated by quality calculation component 120 may comprise one or more types of image quality metrics used to measure quality of image compression. In various implementations, quality calculation component 120 may be configured to calculate any image quality metric that may be used to measure visual degradation of the image compared to an original image.

In various implementations, LOD evaluation component 122 may be configured to evaluate one or more LODs generated for a three-dimensional model. In various implementations, LOD evaluation component 122 may also be configured to output an LOD for a three-dimensional model that meets a predefined image quality target. For example, LOD evaluation component 122 may be configured to output an LOD for a three-dimensional model that meets a predefined image quality target for a predefined scene and/or for a range of distances. Indeed, based on the one or more input parameters received (e.g., ranges of distances, predefined scenes, a target quality, and/or one or more other input parameters), LOD evaluation component 122 may be configured to output an LOD for a three-dimensional model. In various implementations, at least one input parameter received may comprise an image quality target. As used herein, an image quality target may comprise a predefined quality target for a three-dimensional model in one or more predefined scenes and/or at one or more distances. In various implementations, the image quality target for a three-dimensional model may comprise a maximum acceptable deviation from a rendering of the three-dimensional model using an original model (or the original three-dimensional art) for the three-dimensional model. In various implementations, the image quality target may be defined based on one or more image quality metrics. For example, the image quality target may be defined based on one or more image quality metrics described herein (e.g., PSNR, MSE, SSIM, MS-SSIM, LPIPS, and/or other image quality metrics used to measure visual degradation of an image compared to an original image). In some implementations, the image quality target may be set so that the image is “perceptually indistinguishable” from the original. For example, if SSIM is used, a value greater than or equal to 0.99 (i.e., value >=0.99) may be used as the image quality target. This would be perceptually indistinguishable with regards to SSIM, as explained, for example, in “Understanding SSIM” by Jim Nilsson and Tomas Akenine-Möller, which is available at https://arxiv.org/pdf/2006.13846.pdf, and which is incorporated by reference in its entirety herein. In some implementations, the image quality target may accept a certain degree of perceptual degradation. For example, if SSIM is used, a value between 0.80 and 0.85 may be used as the image quality target.

In various implementations, LOD evaluation component 122 may be configured to determine whether an LOD satisfies an image quality target based on one or more image quality metrics calculated for a rendering generated based on the LOD. For example, LOD evaluation component 122 may be configured to determine whether a minimum or candidate LOD satisfies an image quality target for a three-dimensional model based on an image quality metric for an experimental rendering of the three-dimensional model generated using the minimum or candidate LOD. As described herein, an image quality target for a three-dimensional model may comprise a maximum acceptable deviation from a rendering of the three-dimensional model using an original model (or the original three-dimensional art) for the three-dimensional model. In various implementations, to determine whether a minimum or candidate LOD satisfies an image quality target, LOD evaluation component 122 may be configured to determine whether an image quality metric for a rendering of the three-dimensional model generated based on the minimum or candidate LOD is within a maximum acceptable deviation of an image quality metric for a rendering of the three-dimensional model generated based on an original model (or the original three-dimensional art) for the three-dimensional model. For example, LOD evaluation component 122 may be configured to determine whether all renderings, or at least a certain predefined percentage of renderings, generated using the minimum or candidate LOD have an image quality that is within a maximum acceptable deviation of renderings generated based on the original image.

Responsive to a determination that a given LOD satisfies an image quality target, LOD evaluation component 122 may be configured to output the minimum or candidate LOD as the LOD to be used. For example, for a given scene or range of distances for which a minimum or candidate LOD is evaluated, LOD evaluation component 122 may be configured to output the minimum or candidate LOD as the LOD to be used for those parameters responsive to a determination that the minimum or candidate LOD satisfies an image quality target for those parameters.

Responsive to a determination that a given LOD does not satisfy an image quality target, LOD evaluation component 122 may be configured to identify an LOD that satisfies the image quality target. In various implementations, LOD evaluation component 122 may be configured to use a two-dimensional function—one dimension being related to the complexity of mesh and another dimension being related to the complexity of the associated texture. For example, LOD evaluation component 122 may be configured to calculate an image quality metric for each mesh number of triangles (and/or vertices) and texture pixel dimensions and/or quality. Using this function of mesh number of triangles/vertices and texture pixel dimensions/quality, LOD evaluation component 122 may be configured to identify a point where the corresponding image quality metric is within the maximum acceptable deviation from an image quality metric for a rendering of the three-dimensional model using an original model. In other words, LOD evaluation component 122 may be configured to use this function of mesh number of triangles/vertices and texture pixel dimensions/quality to identify an LOD that satisfies the image quality target. In some embodiments, LOD evaluation component 122 may be configured to use a function that utilizes mesh decimator reduction percentage instead of mesh number of triangles/vertices.

In various implementations, LOD evaluation component 122 may be configured to use the two-dimensional function described herein to find a point where the image quality metric satisfies the image quality target and where a second metric is optimized. For example, the second metric may comprise a byte size of the compressed meshes and/or textures (e.g., with the compression methods used the same as compression methods to be used for the digital assets themselves). In some implementations, the second metric comprise an amount of Video RAM (VRAM) storage needed to store the meshes and/or textures.

In various implementations, LOD evaluation component 122 may be configured to calculate, for each of a set of candidate points representing individual candidate LODs, a value that indicates whether an image quality target is satisfied and a value of a second metric. LOD evaluation component 122 may then be configured to filter out candidate points for which the image quality target is not satisfied and chose from the remaining candidate points based on the value of the second metric. For example, after filtering out candidate points for which the image quality target is not satisfied, LOD evaluation component 122 may be configured to choose the remaining candidate point with the best value for the second metric. In various implementations, LOD evaluation component 122 may be configured to output the candidate LOD that corresponds to the chosen candidate point. The candidate LOD that is output may comprise (and be assigned as) the LOD to be used when rendering the three-dimensional object according to these particular input parameters (i.e., the input parameters used originally to generate the reference and experimental renderings of the three-dimensional model). In other words, LOD evaluation component 122 may be configured to identify an LOD for the input parameters received by selecting an LOD that satisfies an image quality target and has an optimal value for a second metric.

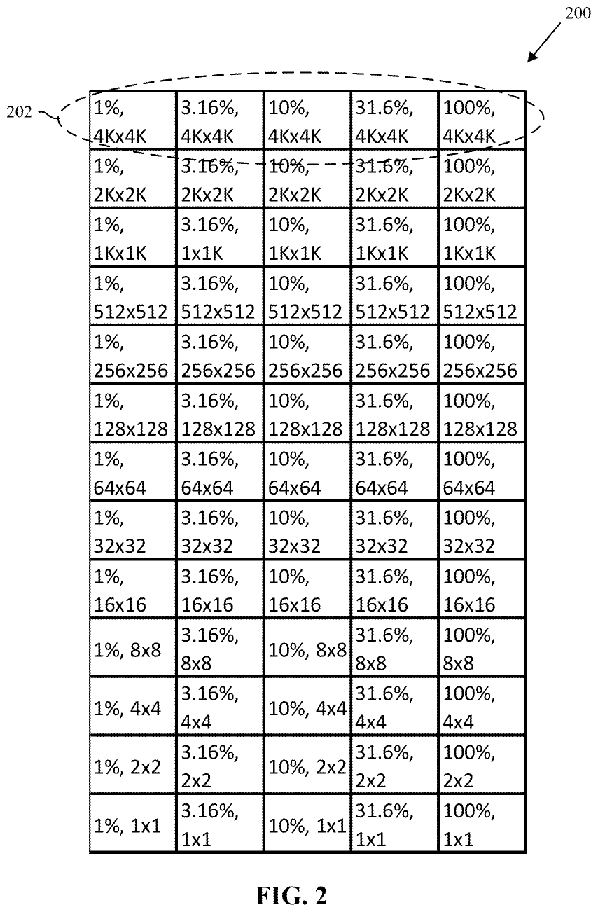

In various implementations, LOD evaluation component 122 may be configured to find this point (e.g., where at least the image quality metric satisfies the image quality target) using a grid of candidate points. For example, FIG. 2 depicts an example reference table 200 comprising candidate points used to identify an LOD that satisfies the image quality target, according to one or more aspects described herein. In various implementations, the candidate points in reference table 200 may represent the output of the two-dimensional function described herein. The two-dimensional function includes information for the meshes and texture pixel sizes. For meshes, LOD evaluation component 122 may be configured to reduce the number of triangles or vertices in logarithmic manner. For example, as depicted in FIG. 2, the number of triangles or vertices in candidate points 202 may include 100%, 31.6% (approximation of 1/sqrt(10)), 10%, 3.16%, 1%, and so on until the number of triangles or vertices for a minimum LOD is reached. For texture pixel sizes, LOD evaluation component 122 may be configured to reduce pixel size twice on each step of reference table 200. For example, if an original texture was 4096×4096 pixels, LOD evaluation component 122 may be configured to use reference data points such as 2048×2048, 1024×1024, 512×512, and so on until the pixel size for a minimum LOD is reached.

In some implementations, LOD evaluation component 122 may be configured to use a re-meshing operation when decimating meshes. Here, the term “re-meshing” is used as an operation over the mesh that changes mesh topology (while most of decimation techniques, including those described in an aforementioned “A General Framework for Mesh Decimation”, cannot change mesh topology, and decimation quality without topology changes may suffer when proceeding towards less complex LODs). In some embodiments, re-meshing can be achieved via voxelization of the existing mesh over some three-dimensional grid (for example, by simply marking a voxel as ‘filled’ if any of the mesh triangles have common points with the respective grid cell), with subsequent conversion of voxels into a new mesh (using, for example, “marching cubes” method), and further decimation of the new mesh. While re-meshing may be an expensive operation in terms of resources involved, it may allow for removal of some of the “holes” in the mesh, simplifying the mesh topology and enabling better decimation towards smaller triangle/vertex numbers. Such re-meshing may be used in some embodiments of the present disclosure, for example, LOD evaluation component 122 may be configured to determine whether to use a re-meshing operation when decimating meshes based on the target settings. In one example, LOD evaluation component 122 may detect that quality of the minimum LOD is insufficient to satisfy image quality target, and may initiate re-meshing (applied to the original mesh, or to any of the already-decimated meshes) with subsequent decimation, to see if an improvement in the image quality can be achieved using re-meshing. In some implementations, when evaluating each LOD, LOD evaluation component 122 may be configured to use both re-meshed and non-remeshed decimations to select the optimal candidate LOD based on an optimal second metric. In other implementations, LOD evaluation component 122 may be configured to utilize one or more other techniques to find a minimum or maximum for the second metric for the candidate points that satisfy the image quality target. For example, LOD evaluation component 122 may be configured to utilize gradient descent, simulated annealing, evolutionary algorithms, genetic algorithms, and/or other similar techniques to find a minimum or maximum for a second metric.

In some implementations, after an LOD has been identified and/or assigned for all necessary three-dimensional models at all necessary distances, rendering generation component 118 may be configured to operate a modified game engine while play-testing a game (and/or during simulated gameplay testing) in a special “test mode” so that it renders each of the frames or some of the frames twice, as described herein with respect to operation 400. For example, rendering generation component 118 may be configured to run the game in “test mode,” rendering each frame twice, once using the original three-dimensional model to obtain the reference image (or “reference rendering”) and a second time, using the result or candidate LOD, to get the “experimental rendering.” Quality calculation component 120 may then be configured to calculate an image quality metric for the original three-dimensional art (based on the reference rendering) and the result or candidate LOD (based on the experimental rendering). Then, LOD evaluation component 122 may be configured to compare the two rendered frames and determine if the image quality metric satisfies an image quality target. If the quality metric does not meet the image quality target, LOD evaluation component 122 may be configured to report the evaluation so that the scene may be included within a list of predefined scenes requiring corrective action. In some embodiments, additional information may be collected related to these metrics that is reported to developers, for example, via a log file or some network protocol. In some embodiments, LOD evaluation component 122 may be configured to adjust LODs (as described herein) and/or adjust LOD ranges (e.g., by increasing the range for deficient LOD generally or for a particular type of scene).

In some embodiments, LOD evaluation component 122 may be configured to evaluate the perceived quality of a video produced by a game by utilizing video quality metrics such as spatio-temporal video structural similarity index (stVSSIM), International Telecommunication Union Video Quality Metrics (ITU-T VQM), and/or other video quality metrics. In such implementations, the predefined scenes described herein may include an animation. In some embodiments, pre-defined scenes may not be static scenes, but may instead be dynamic scenes (with objects and/or camera moving, animated, etc.) and use these video metrics for the evaluation purposes (instead of or in addition to static image metrics such as PSNR or SSIM). This may allow for significantly better perception estimates, for example, as human perception of the video is substantially different (albeit related to) to human perception of the static images.

Electronic storage 130 may include electronic storage media that electronically stores and/or transmits information. The electronic storage media of the electronic storage 130 may be provided integrally (i.e., substantially nonremovable) with one or more components of system 100 and/or removable storage that is connectable to one or more components of system 100 via, for example, a port (e.g., USB port, a Firewire port, and/or other port) or a drive (e.g., a disk drive and/or other drive). The electronic storage 130 may include one or more of optically readable storage media (e.g., optical disks and/or other optically readable storage media), magnetically readable storage media (e.g., magnetic tape, magnetic hard drive, floppy drive, and/or other magnetically readable storage media), electrical charge-based storage media (e.g., EPROM, EEPROM, RAM, and/or other electrical charge-based storage media), solid-state storage media (e.g., flash drive and/or other solid-state storage media), and/or other electronically readable storage media. The electronic storage 130 may be a separate component within system 100, or the electronic storage 130 may be provided integrally with one or more other components of system 100 (e.g., processor 112). Although electronic storage 130 is shown in FIG. 1 as a single entity, this is for illustrative purposes only. In some implementations, the electronic storage 130 may comprise a plurality of storage units. These storage units may be physically located within the same device, or the electronic storage 130 may represent storage functionality of a plurality of devices operating in coordination.

Electronic storage 130 may store software algorithms, information determined by processor 112, information received remotely, and/or other information that enables system 100 to function properly. For example, the electronic storage 130 may store information relating to one or more three-dimensional models, one or more textures, one or more existing LODs to be used to compress a texture, one or more LODs modified according to techniques described herein, and/or other information.

Client computing device(s) 140 (also interchangeably referred to herein as the client computing device 140, the client computing devices 140, or one or more client computing devices 140) may be used by users of system 100 to interface with system 100. The client computing device(s) 140 may be configured as a server device (e.g., having one or more server blades, processors, etc.), a gaming console, a handheld gaming device, a personal computer (e.g., a desktop computer, a laptop computer, etc.), a smartphone, a tablet computing device, an Internet of Things (IoT) device, a wearable device, and/or other device that can be programmed to interface with computer system 110.

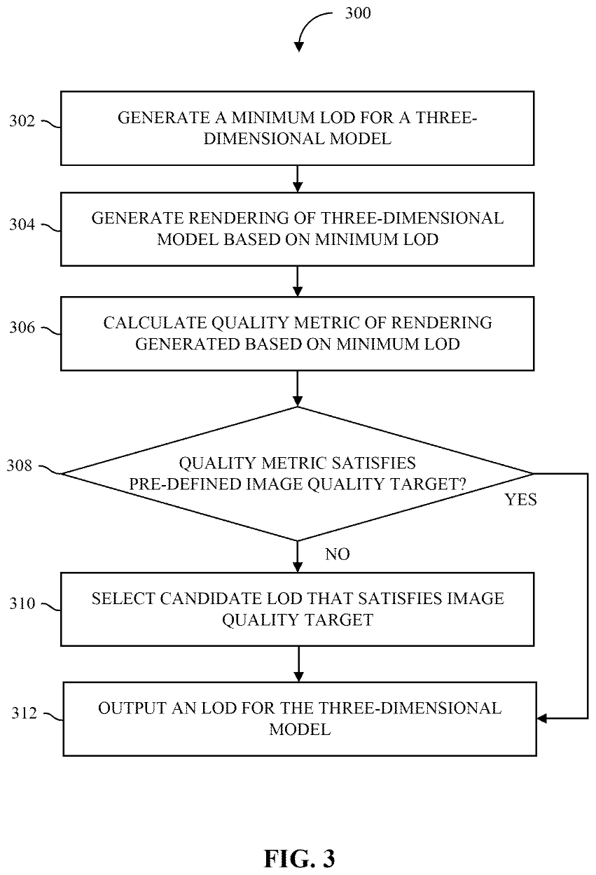

FIG. 3 illustrates an example of a process 300 for generating an LOD to be used to render a computer-generated three-dimensional model that meets a pre-defined quality target, according to one or more aspects described herein. The operations of process 300 presented below are intended to be illustrative and, as such, should not be viewed as limiting. In some implementations, process 300 may be accomplished with one or more additional operations not described, and/or without one or more of the operations discussed. In some implementations, two or more of the operations of process 300 may occur substantially simultaneously. The described operations may be accomplished using some or all of the system components described in detail above.

In an operation 302, process 300 may include generating a minimum LOD for a three-dimensional model. In various implementations, the minimum LOD for a three-dimensional model may be generated based on the original three-dimensional model. In various implementations, one or more existing mesh decimation methods/algorithms and/or texture reduction/compression methods may be used to reduce or decimate meshes or textures of a three-dimensional model to a minimum LOD. In some implementations, operation 302 may be performed by a processor component the same as or similar to LOD generation component 116 shown in FIG. 1 and described herein.

In an operation 304, process 300 may include generating one or more renderings of a three-dimensional model in a predefined scene. For example, an experimental rendering of the three-dimensional model may be generated by generating a rendering of the three-dimensional model in a predefined scene using the minimum LOD generated (or calculated) in operation 302. In various implementations, operation 304 may also include generating a reference rendering of the three-dimensional model by generating a rendering of the three-dimensional model in a predefined scene using an original model (or the original three-dimensional art) for the three-dimensional model. In various implementations, the renderings of the three-dimensional model (e.g., the reference rendering and the experimental rendering) may be generated based on one or more input parameters. For example, the one or more input parameters may specify the predefined scene, a range of distances in which a three-dimensional model may be rendered within a predefined scene, and/or one or more other input parameters. In some implementations, operation 304 may be performed by a processor component the same as or similar to the rendering generation component 118 shown in FIG. 1 and described herein.

In an operation 306, process 300 may include calculating one or more image quality metrics for rendering(s) of a three-dimensional model. For example, image quality metrics may be calculated for an experimental rendering with respect to a reference rendering. In some implementations, operation 306 may be performed by a processor component the same as or similar to the quality calculation component 120 shown in FIG. 1 and described herein.

In an operation 308, process 300 may include determining whether an image quality metric satisfies an image quality target. For example, the image quality target may be specified by one or more input parameters. As described herein, an image quality target for a three-dimensional model may comprise a maximum acceptable deviation from a rendering of the three-dimensional model using an original model (or the original three-dimensional art) for the three-dimensional model. In some implementations, the image quality target may be set so that the image is “perceptually indistinguishable” from the original. In other implementations, the image quality target may accept a certain degree of perceptual degradation. In various implementations, whether an LOD satisfies an image quality target may be determined based on the image quality metric calculated (in operation 306) for the experimental rendering generated based on the LOD (in operation 304). Responsive to a determination that an LOD (e.g., a minimum LOD) does not satisfy an image quality target, process 300 may proceed to operation 310. Responsive to a determination that an LOD (e.g., a minimum LOD) satisfies an image quality target, process 300 may skip operation 310 and proceed to operation 312. In some implementations, operation 308 may be performed by a processor component the same as or similar to the LOD evaluation component 122 shown in FIG. 1 and described herein.

In an operation 310, process 300 may include selecting an LOD that satisfies the image quality target. In various implementations, a two-dimensional function may be used to identify an LOD that satisfies the image quality target. For example, a two-dimensional function of mesh number of triangles/vertices and texture pixel dimensions and/or quality may be used to identify a point where the corresponding image quality metric is within the maximum acceptable deviation from an image quality metric for a rendering of the three-dimensional model using an original model. In some implementations, this two-dimensional function may be used to find a point corresponding to an LOD where the image quality metric satisfies the image quality target and where a second quality metric is optimized. Accordingly, the point may be selected based on the point with the best value for the second quality metric that also satisfies the predefined image quality target. In some implementations, the second quality metric may comprise a byte size of the compressed meshes and/or textures, an amount of Video RAM (VRAM) storage needed to store the meshes and/or textures, and/or one or more other metrics. In various implementations, value(s) indicating (with a certain degree of approximation) whether an image quality target is satisfied and a value of a second metric may be calculated for each of a set of candidate points representing individual candidate LODs. The candidate points for which the image quality target is not satisfied may be filtered out and a candidate point may be chosen from the remaining candidate points based on the value of the second metric. In various implementations, the candidate point may be identified using a reference table, as described herein. In some implementations, operation 310 may be performed by a processor component the same as or similar to the LOD evaluation component 122 shown in FIG. 1 and described herein.

In an operation 312, process 300 may include outputting an LOD for the three-dimensional model. For example, outputting an LOD for a three-dimensional model may comprise assigned the LOD to be used to render the three-dimensional model. In various implementations, the LOD may be assigned to render the three-dimensional model according to the one or more input parameters. For example, the LOD may be assigned to render a three-dimensional model when depicted in a range of distances or in a predefined scene specified by one or more input parameters used to generate the reference rendering and/or experimental rendering used to test the LOD. In various implementations, an LOD may be output (or assigned) for a three-dimensional model responsive to a determination that the LOD satisfies an image quality target. For example, a minimum LOD may be assigned for a three-dimensional model responsive to a determination that the minimum LOD satisfies an image quality target (e.g., in operation 308). In other implementations, an LOD that satisfies an image quality target and is selected based on a second metric may be output (or assigned) for a three-dimensional model. For example, an LOD corresponding to a candidate point selected (e.g., in operation 310) may be assigned for a three-dimensional model. In some implementations, operation 312 may be performed by a processor component the same as or similar to the LOD evaluation component 122 shown in FIG. 1 and described herein.

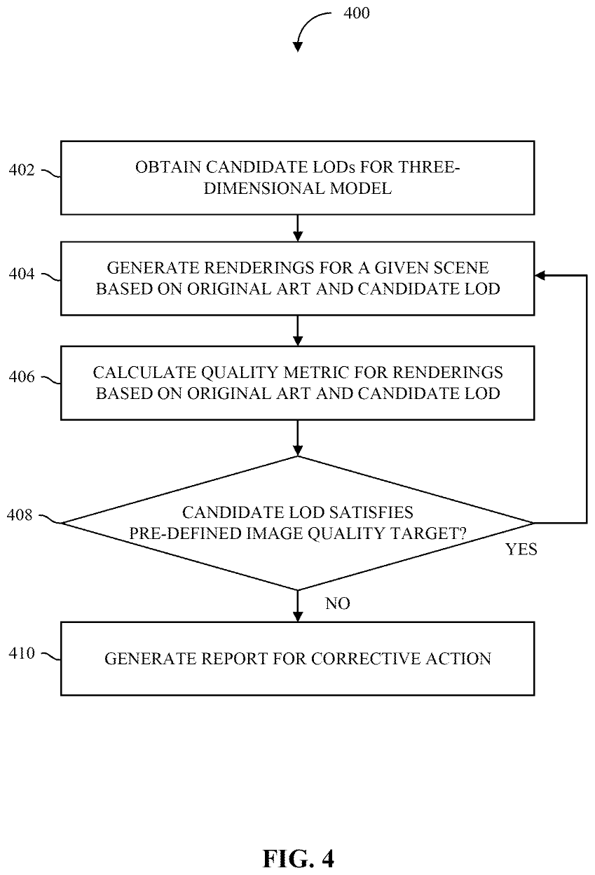

FIG. 4 illustrates an example of a process 400 for evaluating an original three-dimensional model and a candidate LOD, while play-testing a game (and/or during simulated gameplay testing) in a special “test mode” wherein at least one frame is rendered twice, according to one or more aspects described herein. The operations of process 400 presented below are intended to be illustrative and, as such, should not be viewed as limiting. In some implementations, process 400 may be accomplished with one or more additional operations not described, and/or without one or more of the operations discussed. In some implementations, two or more of the operations of process 400 may occur substantially simultaneously. The described operations may be accomplished using some or all of the system components described in detail above.

In an operation 402, process 400 may include obtaining candidate LODs to be used to render a three-dimensional model. In various implementations, each candidate LOD may be assigned to be used to render the three-dimensional model according to one or more input parameters. For example, the input parameter(s) may include one or more ranges of distances, one or more predefined scenes, a targeted quality, and/or one or more other input parameters. In various implementations, a range of distances input parameter may comprise a range of distances from a camera and/or viewpoint in which a specific LOD is intended to be used. In some implementations, operation 402 may be performed by a processor component the same as or similar to LOD generation component 116 shown in FIG. 1 and described herein.

In an operation 404, process 400 may include generating at least two renderings of a three-dimensional model in a given scene (or frame) based on the original model for the three-dimensional model (e.g., the original three-dimensional art for the three-dimensional model) and the candidate LOD assigned for that scene (or distance). The rendering of the three-dimensional model in a predefined scene generated using an original model (or the original three-dimensional art) for the three-dimensional model may comprise a “reference rendering.” The rendering of the three-dimensional model in the predefined scene generated using the candidate LOD assigned to that scene may comprise an “experimental rendering.” In various implementations, the renderings of the three-dimensional model (e.g., the reference rendering and the experimental rendering) may be generated based on one or more input parameters. For example, the one or more input parameters may specify the predefined scene, a range of distances in which a three-dimensional model may be rendered within a predefined scene, and/or one or more other input parameters. In some implementations, operation 404 may be performed by a processor component the same as or similar to the rendering generation component 118 shown in FIG. 1 and described herein.

In an operation 406, process 400 may include calculating quality metric(s) for each rendering of a three-dimensional model. For example, image quality metrics may be calculated for various experimental renderings as compared to the reference rendering. In some implementations, operation 406 may be performed by a processor component the same as or similar to the quality calculation component 120 shown in FIG. 1 and described herein.

In an operation 408, process 400 may include determining whether the candidate LOD satisfies an image quality target. For example, the image quality target may be specified by one or more input parameters. As described herein, an image quality target for a three-dimensional model may comprise a maximum acceptable deviation from a rendering of the three-dimensional model using an original model (or the original three-dimensional art) for the three-dimensional model. In some implementations, the image quality target may be set so that the image is “perceptually indistinguishable” from the original. In other implementations, the image quality target may accept a certain degree of perceptual degradation. In various implementations, whether an LOD satisfies an image quality target may be determined based on the image quality metrics calculated for the experimental rendering and the reference rendering in operation 406. For example, whether the candidate LOD satisfies the image quality target may be determined by determining whether the image quality metric for the experimental rendering is within a maximum acceptable deviation of the image quality metric for the reference rending. Responsive to a determination that the candidate LOD does not satisfy the image quality target, process 400 may proceed to operation 410. Responsive to a determination that the candidate LOD satisfies the image quality target, process 400 may skip operation 410 and return to operation 404, where renderings of the three-dimensional model may be generated for a different scene (e.g., using the original model and the candidate LOD for that scene) until the image quality for each of a predefined set of scenes is evaluated. In some implementations, operation 408 may be performed by a processor component the same as or similar to the LOD evaluation component 122 shown in FIG. 1 and described herein.

In an operation 410, process 400 may include generating a report for some corrective action to be taken. In some implementations, in response to a determination that the candidate LOD does not satisfy the image quality target, the evaluation may be reported so that the scene may be included within a list of scenes requiring corrective action. In some embodiments, the candidate LOD may be automatically adjusted or a range of distances associated with the LOD may be automatically adjusted. For example, the range of distances for the candidate LOD may be increased generally or for the particular type of scene for which the candidate LOD was assigned and did not meet the image quality target. In some implementations, operation 410 may be performed by a processor component the same as or similar to the LOD evaluation component 122 shown in FIG. 1 and described herein.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

The various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application-such as by using any combination of digital processors, analog processors, digital circuits designed to process information, central processing units, graphics processing units, microcontrollers, microprocessors, field programmable gate arrays (FPGAs), application specific integrated circuits (ASICs), a System on a Chip (SoC), and/or other mechanisms for electronically processing information—but such implementation decisions should not be interpreted as causing a departure from the scope of the present invention.

The description of the functionality provided by the different computer-readable instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor(s) 112 may be programmed by one or more additional instructions that may perform some or all of the functionality attributed herein to one of the computer-readable instructions.

The various instructions described herein may be stored in electronic storage, which may comprise random access memory (RAM), read only memory (ROM), and/or other memory. In some implementations, the various instructions described herein may be stored in electronic storage of one or more components of system 100 and/or accessible via a network (e.g., via the Internet, cloud storage, and/or one or more other networks). The electronic storage may store the computer program instructions (e.g., the aforementioned instructions) to be executed by processor(s) 112 as well as data that may be manipulated by processor(s) 112. The electronic storage may comprise floppy disks, hard disks, optical disks, tapes, or other storage media for storing computer-executable instructions and/or data.

Although illustrated in FIG. 1 as a single component, computer system 110 and client computing device(s) 140 may each include a plurality of individual components (e.g., computer devices) each programmed with at least some of the functions described herein. In this manner, some components of computer system 110 and/or associated the client computing device(s) may perform some functions while other components may perform other functions, as would be appreciated. Furthermore, it should be appreciated that although the various instructions are illustrated in FIG. 1 as being co-located within a single processing unit, in implementations in which processor(s) 112 include multiple processing units, one or more instructions may be executed remotely from the other instructions.

Although processor computer system 110, electronic storage 130, and the client computing device(s) 140 are shown to be connected to interface 102 in FIG. 1, any communication medium may be used to facilitate interaction between any components of system 100. One or more components of system 100 may communicate with each other through hard-wired communication, wireless communication, or both. In various implementations, one or more components of system 100 may communicate with each other through a network. For example, computer system 110 may wirelessly communicate with electronic storage 130. By way of non-limiting example, wireless communication may include one or more of radio communication, Bluetooth communication, Wi-Fi communication, cellular communication, infrared communication, or other wireless communication. Other types of communications are contemplated by the present disclosure.

Reference in this specification to “one implementation”, “an implementation”, “some implementations”, “various implementations”, “certain implementations”, “other implementations”, “one series of implementations”, or the like means that a particular feature, design, structure, or characteristic described in connection with the implementation is included in at least one implementation of the disclosure. The appearances of, for example, the phrase “in one implementation” or “in an implementation” in various places in the specification are not necessarily all referring to the same implementation, nor are separate or alternative implementations mutually exclusive of other implementations. Moreover, whether or not there is express reference to an “implementation” or the like, various features are described, which may be variously combined and included in some implementations, but also variously omitted in other implementations. Similarly, various features are described that may be preferences or requirements for some implementations, but not other implementations.

The language used herein has been principally selected for readability and instructional purposes, and it may not have been selected to delineate or circumscribe the inventive subject matter. Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A computer-implemented method of generating a level of detail (LOD) to be used to render a computer-generated three-dimensional model, the method comprising:
generating a minimum LOD for a three-dimensional model;
generating an experimental rendering of the three-dimensional model in a predefined scene using the minimum LOD;
calculating an image quality metric for the experimental rendering;
determining whether the minimum LOD satisfies an image quality target based on the image quality metric for the experimental rendering; and
responsive to a determination that the minimum LOD does not satisfy the image quality target, selecting an LOD that satisfies the image quality target based on a second metric.

2. The computer-implemented method of claim 1, wherein the minimum LOD is generated using an existing mesh decimation method.

3. The computer-implemented method of claim 1, wherein the method further comprises generating a reference rendering of the three-dimensional model in the predefined scene using an original model for the three-dimensional model.

4. The computer-implemented method of claim 3, wherein reference rendering comprises a rendering of the three-dimensional model without applying an LOD to modify the original model for the three-dimensional model.

5. The computer-implemented method of claim 3, the method further comprising:
calculating an image quality metric for the reference rending; and
determining whether the minimum LOD satisfies the image quality target based on the image quality metric for the experimental rendering and the image quality metric for the reference rending.

6. The computer-implemented method of claim 5, wherein the image quality target comprises a maximum acceptable deviation from a rendering, wherein determining whether the minimum LOD satisfies the image quality target comprises:
determining whether the image quality metric for the experimental rendering is within the maximum acceptable deviation of the image quality metric for the reference rending.

7. The computer-implemented method of claim 1, the method further comprising receiving one or more input parameters, wherein the one or more input parameters include at least the image quality metric.

8. The computer-implemented method of claim 7, wherein the at least one input parameter specifies the predefined scene.

9. The computer-implemented method of claim 7, wherein the at least one input parameters specifies a range of distances, wherein the experimental rendering is generated by rendering the three-dimensional model in the predefined scene at one or more distances within the range of distances.

10. The computer-implemented method of claim 7, the method further comprising assigning the selected LOD as an LOD to be used to render the three-dimensional model according to the one or more input parameters.

11. The computer-implemented method of claim 1, wherein selecting the LOD that satisfies the image quality target based on the second metric comprises:
generating candidate LODs using a two-dimensional function of mesh number of triangles and/or vertices and texture pixel dimensions and/or quality;
filtering out candidate LODs that do not satisfy the image quality target; and
selecting the remaining candidate LOD with an optimal value for the second metric.

12. The computer-implemented method of claim 11, wherein selecting the remaining candidate LOD with the optimal value for the second metric comprises selecting the remaining candidate LOD with the highest value of the remaining candidate LOD with the lowest value based on the second metric.

13. The computer-implemented method of claim 1, wherein the second metric comprises a byte size of compressed meshes and/or textures for the three-dimensional model.

14. The computer-implemented method of claim 1, wherein the second metric comprises an amount of Video RAM (VRAM) storage needed to store meshes and/or textures for the three-dimensional model.

15. The computer-implemented method of claim 3, wherein the image quality metric calculated for the experimental rendering is a structural similarity index measure (SSIM) as compared to the reference rendering, and wherein the image quality target comprises a maximum acceptable deviation from the reference rending, the image quality target comprising a value between 0.80 and 0.85.

16. A system for generating a level of detail (LOD) to be used to render a computer-generated three-dimensional model, the system comprising:
one or more processors configured by computer readable instructions to:
generate a minimum LOD for a three-dimensional model;
generate an experimental rendering of the three-dimensional model in a predefined scene using the minimum LOD;
calculate an image quality metric for the experimental rendering;
determining whether the minimum LOD satisfies an image quality target based on the image quality metric for the experimental rendering; and
responsive to a determination that the minimum LOD does not satisfy the image quality target, select an LOD that satisfies the image quality target based on a second metric.

17. The system of claim 16, wherein the minimum LOD is generated using an existing mesh decimation method.

18. The system of claim 16, wherein the one or more processors are further configured to generate a reference rendering of the three-dimensional model in the predefined scene using an original model for the three-dimensional model.

19. The system of claim 18, wherein reference rendering comprises a rendering of the three-dimensional model without applying an LOD to modify the original model for the three-dimensional model.

20. The system of claim 18, wherein the one or more processors are further configured to:
calculate an image quality metric for the reference rending; and
determine whether the minimum LOD satisfies the image quality target based on the image quality metric for the experimental rendering and the image quality metric for the reference rending.

21. The system of claim 20, wherein the image quality target comprises a maximum acceptable deviation from a rendering, wherein to determine whether the minimum LOD satisfies the image quality target, the one or more processors are configured to:
determine whether the image quality metric for the experimental rendering is within the maximum acceptable deviation of the image quality metric for the reference rending.

22. The system of claim 16, wherein the one or more processors are further configured to receive one or more input parameters, wherein the one or more input parameters include at least the image quality metric.

23. The system of claim 22, wherein the at least one input parameter specifies the predefined scene.

24. The system of claim 22, wherein the at least one input parameters specifies a range of distances, wherein the experimental rendering is generated by rendering the three-dimensional model in the predefined scene at one or more distances within the range of distances.

25. The system of claim 22, wherein the one or more processors are further configured to assign the selected LOD as an LOD to be used to render the three-dimensional model according to the one or more input parameters.

26. The system of claim 16, wherein to select the LOD that satisfies the image quality target based on the second metric, the one or more processors are configured to:
generate candidate LODs using a two-dimensional function of mesh number of triangles and/or vertices and texture pixel dimensions and/or quality;
filter out candidate LODs that do not satisfy the image quality target; and
select the remaining candidate LOD with an optimal value for the second metric.

27. The system of claim 26, wherein to select the remaining candidate LOD with the optimal value for the second metric, the one or more processors are configured to select the remaining candidate LOD with the highest value of the remaining candidate LOD with the lowest value based on the second metric.

28. The system of claim 16, wherein the second metric comprises a byte size of compressed meshes and/or textures for the three-dimensional model.

29. The system of claim 16, wherein the second metric comprises an amount of Video RAM (VRAM) storage needed to store meshes and/or textures for the three-dimensional model.

30. The system of claim 18, wherein the image quality metric calculated for the experimental rendering is a structural similarity index measure (SSIM) as compared to the reference rendering, and wherein the image quality target comprises a maximum acceptable deviation from the reference rending, the image quality target comprising a value between 0.80 and 0.85
